(19) United States
(12) Patent Application Publication
(10) Pub. No.: US 2025/0081073 A1
(43) Pub. Date: Mar. 6, 2025

(54) INTER-RADIO ACCESS TECHNOLOGY (RAT) HANDOVER FOR WIRELESS DEVICES

(71) Applicant: QUALCOMM Incorporated, San Diego, CA (US)

(72) Inventors: Avinash SHRIVASTAVA, Hyderabad (IN); Liangping MA, San Diego, CA (US)

(21) Appl. No.: 18/457,946

(22) Filed: Aug. 29, 2023

(51) Int. Cl. H04W 36/32; H04W 36/00

(52) U.S. Cl. CPC H04W 36/326; H04W 36/00835

(57) ABSTRACT

Methods, systems, and devices for wireless communications are described. A second wireless device (such as a head-mounted display (HMD) device) may communicate with a first wireless device (such as a user equipment (UE)) via a tethered wireless connection. The tethered wireless connection may be associated with a first type of radio access technology (RAT). The first wireless device may obtain an indication of one or more access points (APs) associated with a second type of RAT. The first wireless device may transmit an indication of one or more candidate APs for a handover of the second wireless device from the first wireless device to maintain the connectivity between the second wireless device and a network. As such, the second wireless device may use the wireless characteristics to determine whether to handover to a candidate AP or maintain the tethered wireless connection with the first wireless device.

### FIELD OF TECHNOLOGY

The following relates to wireless communications, including inter-radio access technology (RAT) handover for wireless devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support a first wireless device (e.g., a UE) facilitating an inter-radio access technology (RAT) handover for a second wireless device (e.g., a head-mounted display (HMD), wireless earbud, wearable device, augmented reality (AR) glasses, virtual reality (VR) glasses, or other peripheral device) that communicates with a network via a tethered connection to the first wireless device using a first RAT. For example, the described techniques provide for the second wireless device to receive from the first wireless device an indication of one or more candidate access points (APs) for handover of the second wireless device from the first RAT to a second RAT. For example, the first wireless device may identify that a QoS parameter associated with a tethered connection with the second wireless device via the first RAT is below a QoS threshold. As such, the first wireless device may identify one or more APs within range of the first wireless device that may be capable of serving a connection between the second wireless device and the network via the second RAT. In some examples, the first wireless device may identify the one or more APs using Non-3GPP inter working function (N3IWF) signaling. For instance, the first wireless device may transmit the N3IWF signaling to an associated core network (e.g., a 5G core network). The N3IWF may serve as a gateway such that the first wireless device may receive, from the core network, wireless local area network (WLAN) AP information for APs within range of the first wireless device. As such, the first wireless device may perform a WLAN AP scanning procedure to identify respective wireless characteristics for each of the APs indicated by the core network. Based on the respective wireless characteristics, the first wireless device may determine transmit an indication of set of candidate APs for the second wireless device to perform a handover. The second wireless device may receive the indication of handover that includes indication of the candidate APs. As such, the second wireless device may determine whether to handover to one of the candidate APs, continue the tethered connection with the second wireless device, or both.

A method for wireless communications by a first wireless device is described. The method may include communicating, with a second wireless device via a tethered wireless connection between the first wireless device and the second wireless device, the tethered wireless connection associated with a first type of RAT, the first wireless device providing connectivity between the second wireless device and a network, obtaining an indication of one or more APs associated with a second type of RAT and within a range of the first wireless device, and transmitting, based on one or more performance parameters associated with the tethered wireless connection, an indication of one or more candidate APs of the one or more APs for a handover of the second wireless device from the first wireless device to maintain the connectivity between the second wireless device and the network.

A first wireless device for wireless communications is described. The first wireless device may include one or more memories storing processor executable code, and one or more processors coupled with the one or more memories. The one or more processors may individually or collectively operable to execute the code to cause the first wireless device to communicating, with a second wireless device via a tethered wireless connection between the first wireless device and the second wireless device, the tether wireless connection associated with a first type of RAT, the first wireless device providing connectivity between the second wireless device and a network, obtain an indication of one or more APs associated with a second type of RAT and within a range of the first wireless device, and transmit, based on one or more performance parameters associated with the tethered wireless connection, an indication of one or more candidate APs of the one or more APs for a handover of the second wireless device from the first wireless device to maintain the connectivity between the second wireless device and the network.

Another first wireless device for wireless communications is described. The first wireless device may include means for communicating, with a second wireless device via a tethered wireless connection between the first wireless device and the second wireless device, the tethered wireless connection associated with a first type of RAT, the first wireless device providing connectivity between the second wireless device and a network, means for obtaining an indication of one or more APs associated with a second type of RAT and within a range of the first wireless device, and means for transmitting, based on one or more performance parameters associated with the tethered wireless connection, an indication of one or more candidate APs of the one or more APs for a handover of the second wireless device from the first wireless device to maintain the connectivity between the second wireless device and the network.

A non-transitory computer-readable medium storing code for wireless communications is described. The code may include instructions executable by a processor to communicating, with a second wireless device via a tethered wireless connection between the first wireless device and the second wireless device, the tether wireless connection associated with a first type of RAT, the first wireless device providing connectivity between the second wireless device and a network, obtain an indication of one or more APs associated with a second type of RAT and within a range of the first wireless device, and transmit, based on one or more performance parameters associated with the tethered wireless connection, an indication of one or more candidate APs of the one or more APs for a handover of the second wireless device from the first wireless device to maintain the connectivity between the second wireless device and the network.

In some examples of the method, first wireless devices, and non-transitory computer-readable medium described herein, obtaining the indication of the one or more APs associated with the second type of RAT may include operations, features, means, or instructions for transmitting, to the network, an indication of a geographic location of the first wireless device and receiving, from the network, the indication of the one or more APs in accordance with the geographic location of the first wireless device.

In some examples of the method, first wireless devices, and non-transitory computer-readable medium described herein, the network includes a N3IWF and the first wireless device communicates with the network via N3IWF signaling.

In some examples of the method, first wireless devices, and non-transitory computer-readable medium described herein, obtaining the indication of the one or more APs associated with the second type of RAT may include operations, features, means, or instructions for performing an AP scanning procedure identifying the one or more APs.

Some examples of the method, first wireless devices, and non-transitory computer-readable medium described herein may further include operations, features, means, or instructions for receiving, from each AP of the one or more APs, respective wireless characteristics and determining the one or more candidate APs of the one or more APs for the handover may be based on the respective wireless characteristics received from each AP.

In some examples of the method, first wireless devices, and non-transitory computer-readable medium described herein, transmitting the indication of the one or more candidate APs for the handover may include operations, features, means, or instructions for transmitting the respective wireless characteristics for each of the one or more candidate APs.

In some examples of the method, first wireless devices, and non-transitory computer-readable medium described herein, the indication of the one or more candidate APs includes an ordering of the one or more candidate APs in accordance with a handover priority of each candidate AP of the one or more candidate APs and the handover priority may be based at least in part the respective wireless characteristics for each of the one or more candidate APs.

In some examples of the method, first wireless devices, and non-transitory computer-readable medium described herein, the ordering of the handover priority may be based on a respective received signal strength indicator (RSSI) value included in each of the respective wireless characteristics for each of the one or more candidate APs.

In some examples of the method, first wireless devices, and non-transitory computer-readable medium described herein, each respective wireless characteristics received from each AP includes one or more of an AP frequency, a RSSI value, a service set identifier (SSID), a medium access control (MAC) address, and an operating channel bandwidth.

Some examples of the method, first wireless devices, and non-transitory computer-readable medium described herein may further include operations, features, means, or instructions for terminating the tethered wireless connection in accordance with transmitting the indication of the one or more candidate APs for the handover from the first wireless device.

Some examples of the method, first wireless devices, and non-transitory computer-readable medium described herein may further include operations, features, means, or instructions for receiving an indication that the second wireless device rejects the handover from the first wireless device and maintaining the tethered wireless connection in accordance with the indication that the second wireless device rejects the handover from the first wireless device.

In some examples of the method, first wireless devices, and non-transitory computer-readable medium described herein, the one or more performance parameters associated with the tethered wireless connection include a quality of service value associated with the tethered wireless connection and transmitting the indication of the one or more candidate APs for the handover may be based on the quality of service value satisfying a threshold value.

In some examples of the method, first wireless devices, and non-transitory computer-readable medium described herein, the first wireless device may be a UE, and the second wireless device may be a HMD device, augmented reality glasses, or virtual reality glasses.

In some examples of the method, first wireless devices, and non-transitory computer-readable medium described herein, the first type of RAT may be a cellular RAT and the second type of RAT may be a wireless local area network RAT.

A method for wireless communications by a second wireless device is described. The method may include communicating, with a first wireless device via a tethered wireless connection between the first wireless device and the second wireless device, the tethered wireless connection associated with a first type of RAT, the first wireless device providing connectivity between the second wireless device and a network and receiving, based on one or more performance parameters associated with the tethered wireless connection, an indication of one or more candidate APs associated with a second type of RAT and within a range of the second wireless device, the one or more candidate APs for a handover of the second wireless device from the first wireless device to maintain the connectivity between the second wireless device and the network.

A second wireless device for wireless communications is described. The second wireless device may include one or more memories storing processor executable code, and one or more processors coupled with the one or more memories. The one or more processors may individually or collectively operable to execute the code to cause the second wireless device to communicating, with a first wireless device via a tethered wireless connection between the first wireless device and the second wireless device, the tether wireless connection associated with a first type of RAT, the first wireless device providing connectivity between the second wireless device and a network and receive, based on one or more performance parameters associated with the tethered wireless connection, an indication of one or more candidate APs associated with a second type of RAT and within a range of the second wireless device, the one or more candidate APs for a handover of the second wireless device from the first wireless device to maintain the connectivity between the second wireless device and the network.

Another second wireless device for wireless communications is described. The second wireless device may include means for communicating, with a first wireless device via a tethered wireless connection between the first wireless device and the second wireless device, the tethered wireless connection associated with a first type of RAT, the first wireless device providing connectivity between the second wireless device and a network and means for receiving, based on one or more performance parameters associated with the tethered wireless connection, an indication of one or more candidate APs associated with a second type of RAT and within a range of the second wireless device, the one or more candidate APs for a handover of the second wireless device from the first wireless device to maintain the connectivity between the second wireless device and the network.

A non-transitory computer-readable medium storing code for wireless communications is described. The code may include instructions executable by a processor to communicating, with a first wireless device via a tethered wireless connection between the first wireless device and the second wireless device, the tether wireless connection associated with a first type of RAT, the first wireless device providing connectivity between the second wireless device and a network and receive, based on one or more performance parameters associated with the tethered wireless connection, an indication of one or more candidate APs associated with a second type of RAT and within a range of the second wireless device, the one or more candidate APs for a handover of the second wireless device from the first wireless device to maintain the connectivity between the second wireless device and the network.

In some examples of the method, second wireless devices, and non-transitory computer-readable medium described herein, receiving the indication of the one or more candidate APs for the handover may include operations, features, means, or instructions for receiving respective wireless characteristics for each of the one or more candidate APs.

In some examples of the method, second wireless devices, and non-transitory computer-readable medium described herein, the indication of the one or more candidate APs includes an ordering of the one or more candidate APs in accordance with a handover priority of each candidate AP of the one or more candidate APs and the handover priority may be based at least in part the respective wireless characteristics for each of the one or more candidate APs.

In some examples of the method, second wireless devices, and non-transitory computer-readable medium described herein, each respective wireless characteristics received from each AP includes one or more of an AP frequency, an RSSI value, an SSID, a MAC address, and an operating channel bandwidth.

Some examples of the method, second wireless devices, and non-transitory computer-readable medium described herein may further include operations, features, means, or instructions for performing, at a geographic location of the second wireless device, an AP scanning procedure for each of the one or more candidate APs for the handover and determining a respective service quality associated with each of the one or more candidate APs based on performing the AP scanning procedure.

Some examples of the method, second wireless devices, and non-transitory computer-readable medium described herein may further include operations, features, means, or instructions for determining that a first candidate AP of the one or more candidate APs may have a highest associated service quality out of the one or more candidate APs and the first wireless device, terminating the tethered wireless connection based on determining that the first candidate AP of the one or more candidate APs may have the highest associated service quality, and transmitting, to the first candidate AP, a request to establish a wireless connection providing connectivity between the second wireless device and the network in accordance with the handover from the first wireless device.

Some examples of the method, second wireless devices, and non-transitory computer-readable medium described herein may further include operations, features, means, or instructions for transmitting, to the first wireless device, an indication that the second wireless device may have rejected the handover from the first wireless device and will maintain the tethered wireless connection with the first wireless device and maintaining the tethered wireless connection in accordance with the indication that the second wireless device rejects the handover from the first wireless device.

In some examples of the method, second wireless devices, and non-transitory computer-readable medium described herein, the one or more performance parameters associated with the tethered wireless connection include a quality of service value associated with the tethered wireless connection and transmitting the indication of the one or more candidate APs for the handover may be based on the quality of service value satisfying a threshold value.

In some examples of the method, second wireless devices, and non-transitory computer-readable medium described herein, the first wireless device may be a UE, and the second wireless device may be a HMD device, augmented reality glasses, or virtual reality glasses.

In some examples of the method, second wireless devices, and non-transitory computer-readable medium described herein, the first type of RAT may be a cellular RAT and the second type of RAT may be a wireless local area network RAT.

### BRIEF DESCRIPTION OF THE DRAWINGS

FIG. 1 shows an example of a wireless communications system that supports inter-radio access technology (RAT) handover for wireless devices in accordance with one or more aspects of the present disclosure.

FIG. 2 shows an example of a wireless communications system that supports inter-RAT handover for wireless devices in accordance with one or more aspects of the present disclosure.

FIG. 3 shows an example of a process flow that supports inter-RAT handover for wireless devices in accordance with one or more aspects of the present disclosure.

FIGS. 4 and 5 show block diagrams of devices that support inter-RAT handover for wireless devices in accordance with one or more aspects of the present disclosure.

FIG. 6 shows a block diagram of a communications manager that supports inter-RAT handover for wireless devices in accordance with one or more aspects of the present disclosure.

FIG. 7 shows a diagram of a system including a device that supports inter-RAT handover for wireless devices in accordance with one or more aspects of the present disclosure.

FIGS. 8 through 11 show flowcharts illustrating methods that support inter-RAT handover for wireless devices in accordance with one or more aspects of the present disclosure.

### DETAILED DESCRIPTION

In some examples of wireless communications, a first wireless device (e.g., a UE) may provide access to a wireless network (e.g., a cellular network) to a second wireless device (e.g., a head-mounted display (HMD) device, wireless earbud, wearable device, augmented reality glasses (AR), virtual reality glasses (VR), or other peripheral device) via a tethered connection. In some examples, a tethered connection may include the second wireless device (e.g., that is not connected to a wireless network) wirelessly connecting to the first wireless device to communicate with the wireless network via the first wireless device. For example, the second wireless device may establish a tethered wireless connection with the first wireless device (e.g., a user equipment (UE)), such that the first wireless device may communicate with the network on behalf of the second wireless device using a first type of radio access technology (RAT) (e.g., 5G-NR). In some examples, however, the quality of service (QOS) for the tethered connection using the first type of RAT may decrease over time (e.g., resulting in a reduced data rate). As such, it may be advantageous for the second wireless device to handover from the first wireless device to a second wireless device using a second type of RAT to communicate with the network (such as an access point (AP) that uses a wireless local area network (WLAN)). For example, one or more APs may be within geographic coverage of the second wireless device, and the second wireless device may select one of the APs for handover to increase the quality and reliability of the connection with the network. However, scanning for the one or more APs may increase power expenditure at the second wireless device, reducing the battery life of the second wireless device. Additionally, or alternatively, the second wireless device may perform a lower quantity of WLAN AP scans within a duration of time compared to the first wireless device, which may reduce the efficiency of the handover procedure.

According to some techniques described herein, the first wireless device may identify one or more candidate APs for handover on behalf of the second wireless device. For example, the first wireless device may identify that a QoS parameter associated with the tethered connection with the second wireless device via a first RAT is below a QoS threshold. As such, the first wireless device may identify one or more APs within range of the first wireless device that may be capable of serving a connection between the second wireless device and the network via a second RAT. In some examples, the first wireless device may identify the one or more APs using Non-3GPP inter working function (N3IWF) signaling. For instance, the first wireless device may transmit the N3IWF signaling to an associated 5G core network (5GCN). The N3IWF may serve as a gateway such that the first wireless device may receive, from the 5GCN, WLAN AP information for APs within range of the first wireless device. As such, the first wireless device may perform a WLAN AP scanning procedure to identify respective wireless characteristics for each of the APs indicated by the 5GCN. Based on the respective wireless characteristics, the first wireless device may determine to transmit an indication of set of candidate APs for the second wireless device to perform a handover. The second wireless device may receive the indication of handover that includes the indication of the candidate APs. As such, the second wireless device may determine whether to handover to one of the candidate APs, or continue the tethered connection with the first wireless device.

Aspects of the disclosure are initially described in the context of wireless communications systems and a process flow. Aspects of the disclosure are further illustrated by and described with reference to apparatus diagrams, system diagrams, and flowcharts that relate to inter-RAT handover for HMD devices.

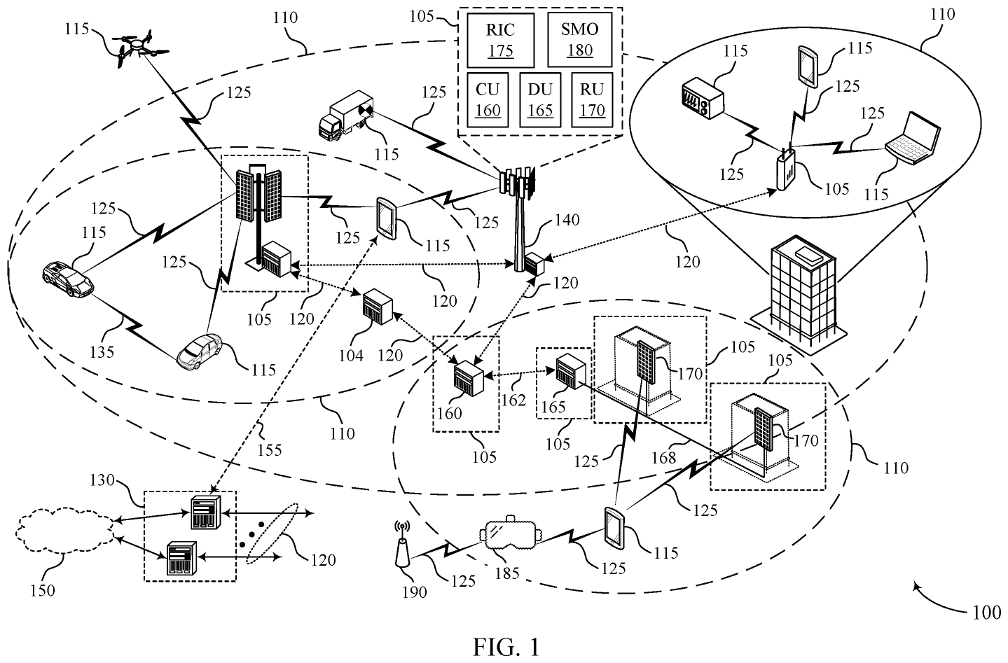

FIG. 1 shows an example of a wireless communications system 100 that supports inter-RAT handover for wireless devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an AP, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1,F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support inter-RAT handover for wireless devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given RAT (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of wireless communications system 100, a first wireless device (such as a UE 115) may provide access to a core network 130, and by extension to IP services 150, to a second wireless device (such as an HMD 185, wireless earbud, wearable device, AR glasses, VR glasses, or other peripheral device) via a communication link 125. For example, the second wireless device may establish a tethered wireless connection with the first wireless device, such that the first wireless device may communicate with the core network 130 on behalf of the second wireless device using a first type of RAT (e.g., 5G-NR). In some examples, however, the QoS for the tethered connection using the first type of RAT may decrease over time (e.g., resulting in a reduced data rate). As such, it may be advantageous for the second wireless device to handover from the first wireless device to a third wireless device (such as an AP 190) using a second type of RAT (such as Wi-Fi) to continue communicating with the network.

According to the techniques described herein, the first wireless device may identify one or more candidate APs 190 for an inter-RAT handover of the second wireless device. For example, the first wireless device may be aware that a QoS parameter associated with the tethered wireless connection with the second wireless device via the first RAT is below a QoS threshold. As such, the first wireless device may identify one or more APs 190 within range of the first wireless device that may be capable of serving (via a wireless communications link 125) a connection between the second wireless device and the network via the second RAT. In some examples, the first wireless device may identify the one or more APs 190 using N3IWF signaling. For instance, the first wireless device may transmit the N3IWF signaling to an associated 5GCN. The N3IWF may serve as a gateway such that the first wireless device may receive, from the 5GCN, WLAN AP information for APs 190 within range of the first wireless device. As such, the first wireless device may perform a WLAN AP scanning procedure to identify respective wireless characteristics for each of the APs 190 indicated by the 5GCN. Based on the respective wireless characteristics, the first wireless device may transmit an indication of set of candidate APs 190 for the second wireless device to perform a handover. The second wireless device may receive the indication of handover that includes indication of the candidate APs 190. As such, the second wireless device may determine whether to handover to one of the candidate APs 190, continue the tethered connection with the first wireless device, or both.

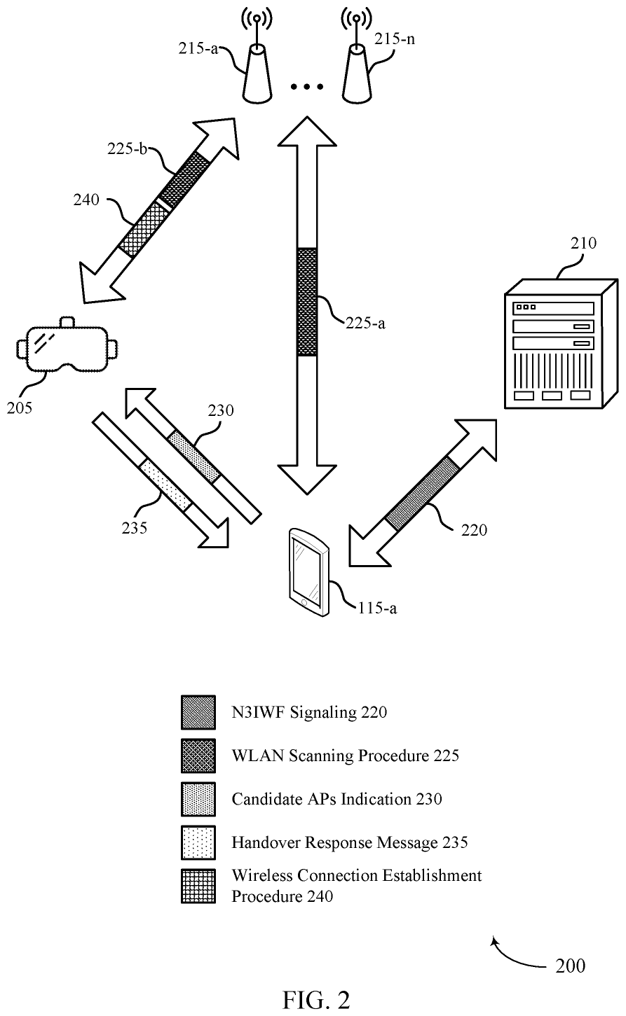

FIG. 2 shows an example of a wireless communications system 200 that supports inter-RAT handover for wireless devices in accordance with one or more aspects of the present disclosure. In some examples, wireless communications system 200 may implement or be implemented by one or more aspects of wireless communications system 100. For example, wireless communications system 200 may include a UE 115-a, which may be an example of a first wireless device and a UE 115 as described with reference to FIG. 1, an HMD 205, which may be an example of a second wireless device and an HMD 185 as described with reference to FIG. 1, and

APs 215-a through AP 215-n, which may be examples of APs 190 as described with reference to FIG. 1. Additionally, FIG. 2 may include a core network device 210, which may be an example of a 5GCN or another cellular network device, and may be associated with or a component of a core network, such as the core network 130 described with reference to FIG. 1.

In some examples, the UE 115-a may communicate with an HMD 205 (e.g., an HMD 185, as described with reference to FIG. 1). In some cases, the HMD 205 may be an example of tethered display AR glasses. For instance, the HMD 205 may communicate with the UE 115-a via a tethered wireless connection, where the UE 115-a may include an application associated with one or more extended reality (XR) functions. In such examples, the UE 115-a may run the application that uses capabilities of the UE 115-a to run AR or mixed reality (MR) at the HMD 205. In some examples, the tethered wireless connection between the UE 115-a and the HMD 205 may be hidden to the application and may tether an XR runtime application programming interface (API) on the UE 115-a to XR runtime core functions on the HMD 205. That is, the tethered wireless connection between the UE 115-a and the HMD 205 may be an example of an XR link.

As illustrated in FIG. 2, the wireless communications system may additionally include multiple APs 215 (e.g., AP 215-a through AP 215-n), which may be respective examples of an AP 190, as described with reference to FIG. 1. Each AP 215 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP 215), and a multi-link AP (also referred to as an AP multi-link device (MLD)), as well as cellular (such as 3GPP, 4G LTE, 5G or 6G) base stations or other cellular network nodes such as a Node B, an eNB, a gNB, a TRP or another type of device or equipment included in a RAN, including O-RAN network entities. Additionally or alternatively, each AP 215 can be or represent an AP Wi-Fi device (such as a WLAN AP).

In some examples, the UE 115-a may communicate with a network on behalf of the HMD 205 using the wireless tethered connection. For example, the UE 115-a may be associated with a first type of RAT and may communicate with a portion of the network corresponding to the first type of RAT. For instance, the first type of RAT may be 5G-NR and the UE 115-a may communicate with a network using 5G communications. As such, the HMD 205 may communicate with the network via the wireless tethered connection established with the UE 115-a. In some examples, however, a quality of service QoS associated with the first type of RAT may decrease over time. For instance, the radio signal strength between the UE 115-a and the 5G core network may decrease below a quality threshold. For example, the UE and the network may perform RRC based measurements, and determine one or more parameters associated with the QoS of the connection between the UE and the network (e.g., reference signal received power (RSRP), reference signal received quality (RSRQ), received signal strength indicator (RSSI), channel quality indicator (CQI), 5G QoS indicator (5QI), among other examples). Additionally, or alternatively, the signal strength of the tethered wireless connection between the UE 115-a and the HMD 205 may decrease below a quality threshold. In such examples, the reduced signal strength may trigger a radio link failure (RLF) associated with the first type of RAT-which may decrease service quality at the HMD 205, reducing XR user experience.

In cases of reduced service quality corresponding to the first type of RAT, it may be advantageous for the HMD 205 to handover the tethered wireless connection from the UE 115-a to a wireless device associated with a second type of RAT. For instance, the HMD 205 may be within a geographic coverage area of one or more of the APs 215 which may communicate with the network in accordance with a RAT that is different than 5G-NR (such as Wi-Fi). In some examples, communications with the second type of RAT may be associated with a greater QoS compared to the first type of RAT associated with the UE 115-a. While examples provided herein discuss the first type of RAT as 5G-NR and the second type of RAT as Wi-Fi, it is understood that the first and second type of RATs may be any of a quantity of different types of RATs (such as Bluetooth, Wi-Fi, global system for mobile communications (GSM), universal mobile telecommunications system (UMTS), LTE or 5G-NR).

If the UE 115-a determines that radio conditions associated with the HMD 205 and the network are low (e.g., a value for QoS for the first type of RAT is below a threshold) the UE 115-a may transmit a handover request to the HMD 205, where the handover request indicates for the HMD 205 to handover the wireless tethered connection with the UE 115-a to an AP 215 of the one or more APs 215. In some examples, the UE 115-a may determine one or more candidate APs 215 to indicate to the HMD 205 in the handover request. The UE 115-a may determine the one or more candidate APs 215 for handover based on obtaining information associated with a set of APs 215 within the geographic coverage area of the UE 115-a.

In some implementations, the UE 115-a may use N3IWF signaling 220 with the network to determine the set of APs 215 within the geographic coverage area of the UE 115-a. In some examples, the N3IWF acts as a gateway for a core network device 210 with support for control-plane (N2) and user-plane (N3) interface towards the core network device 210. Additionally, N3IWF may provide a secure connection for the UE 115-a accessing the core network device 210 over non-3GPP access network with support for internet protocol security (IPsec) tunnel establishment between the UE 115-a and the N3IWF. For instance, the N3IWF may terminate internet key exchange (IKE) (e.g., IKEv2) or IPsec protocols with the UE 115-a over a network uplink (NWu) and relay (e.g., over N2) information used to authenticate the UE 115-a and authorize its access to the core network device 210.

In some examples, termination of N2 and N3 interfaces to the core network device 210 may be for control plane and user plane, respectively. In examples of control-plane for untrusted non-3GPP access, the UE 115-a and N3IWF may use a user datagram protocol (UDP) to enable network address translation (NAT) traversal for the IKEv2 and IPsec traffic (e.g., to establish the user-plane for N3IWF). The control-plane may include one or more of an access and mobility management function (AMF), a session management function (SMF), an authentication server function (AUSF), unified data management (UDM), and a policy control function (PCF). In examples of user-plane for untrusted non-3GPP access, the UE 115-a and N3IWF may establish a protocol data unit (PDU) layer for communication of data between the UE 115-a and the core network device 210. The user-plane may include a user plane function (UPF).

In accordance with the N3IWF signaling 220, the UE 115-a may obtain WLAN information associated with the one or more APs 215 which are in vicinity of the UE 115-a (e.g., within a geographic coverage area of the UE 115-a). As part of the N3IWF signaling 220, the UE 115-a may transmit a current location of the UE 115-a to the core network device 210. In accordance with receiving the current location of the UE 115-a, the core network device 210 may send a query to a WLAN server of the network that is associated with APs 215. As such, the query may request identification of each AP 215 within the geographic coverage area of the current location of the UE 115-a. In response to the query, the WLAN server of the network may transmit an indication of a set of APs 215 within the geographic coverage area of the current location of the UE 115-a. In some cases, the core network device 210 may communicate with the WLAN server using backhaul communications (via a backhaul link). As such, the core network device 210 may transmit to the UE 115-a (as part of the N3IWF signaling 220) the indication of the set of APs 215 provided by the WLAN server.

By receiving the indication of the set of APs 215 from the core network device 210, the UE 115-a may refrain from performing a broader WLAN AP 215 scan to first identify the set of APs 215, which may reduce delay in identifying the one or more candidate APs 215. In some examples, however, the UE 115-a may refrain from exchanging the N3IWF signaling 220 with the core network device 210 and instead perform the broader WLAN AP 215 scan to identify the set of APs 215 within the geographic coverage area of the UE 115-a.

Based on determining the set of APs 215 (via the N3IWF signaling 220 or performing a broader WLAN AP 215 scan), the UE 115-a may perform a WLAN scanning procedure 225 (e.g., a WLAN scanning procedure 225-a) with each of the set of APs 215. By using the WLAN scanning procedure 225-a, the UE 115-a may determine respective wireless characteristics for each AP 215 of the set of APs 215. For example, the UE 115-a may receive from each AP 215, a respective AP 215 frequency, a respective service set identifier (SSID), a respective MAC address, and a respective operating channel bandwidth. Additionally, or alternatively, the UE 115-a may determine a respective RSSI for each of the APs 215 based on signaling exchanged with each of the APs 215.

In some examples, the UE 115-a may determine the one or more candidate APs 215 based on the respective wireless characteristics received from each of the set of APs 215. For instance, the UE 115-a may order the set of APs 215 (such as in a handover priority list) based on a service quality associated with each of the set of APs 215. That is, the UE 115-a may determine the order of handover priority list based on the respective RSSI for each of the APs 215 (e.g., ordered from highest RSSI to lowest RSSI). In some cases, the UE 115-a may select a subset of APs 215 from the set of APs 215 as the one or more candidate APs 215. For example, the UE 115-a may determine to select APs 215 with a respective RSSI value above a signal strength threshold to include in the one or more candidate APs 215. In some examples, the UE 115-a may determine the signal strength threshold based on the QoS value associated with communications using the first type of RAT. That is, the UE 115-a may select candidate APs 215 with respective RSSI values greater than the RSSI value associated with the first type of RAT. Additionally, or alternatively, the UE 115-a may select the candidate APs 215 from the set of APs 215 using any combination of the respective wireless characteristics associated with each of the APs 215.

Based on determining the one or more candidate APs 215, the UE 115-a may transmit the handover request to the HMD 205. For example, the UE 115-a may transmit a candidate APs indication 230 to the HMD 205. In some examples, the candidate APs indication 230 may include one or more of the respective wireless characteristics associated with each of the candidate APs 215.

Based on receiving the handover request (e.g., that includes the candidate APs indication 230), the HMD 205 may determine which wireless device to use for wireless communications with the network. In some examples, the HMD 205 may evaluate the one or more candidate APs 215 and select a first AP 215 from the candidate APs 215 based on one or more of the respective wireless characteristics associated with the first AP 215. For instance, the HMD 205 may select the first AP 215 based on the first AP 215 having a highest associated RSSI value of the one or more candidate APs 215. Additionally, or alternatively, the HMD 205 may select the first AP 215 based on any combination of the respective wireless characteristics associated with the first AP 215 (e.g., the RSSI value, the AP 215 frequency, the SSID, a respective MAC address, and the operating channel bandwidth). Based on selecting the first AP 215, the HMD 205 may determine to initiate a tethering terminating procedure with the UE 115-a. For example, the HMD 205 may transmit a handover response message 235 that indicates the termination of the tethered wireless connection with the UE 115-a, and as such, the UE 115-a and HMD 205 may respectively terminate the tethered wireless connection. The HMD 205 may perform a wireless connection establishment procedure 240 with the first AP 215, in accordance with selecting the first AP 215 for handover. For instance, as part of the wireless connection establishment procedure 240, the HMD 205 may transmit a request to establish a wireless connection with the first AP 215 to maintain connectivity between the HMD 205 and the network. As such, the first AP 215 may transmit a response to the HMD 205 indicating whether the first AP 215 accepts or rejects the request. If the first AP 215 accepts the request, the HMD 205 may complete the handover and establish the wireless connection with first AP 215. If the first AP 215 rejects the request, the HMD 205 may perform the wireless connection establishment procedure 240 with a second AP 215 of the candidate APs 215 or maintain the wireless tethered connection with the UE 115-a. In some examples, the HMD 205 terminate the wireless tethered connection after completing handover to a candidate AP 215. In some examples, the HMD 205 may terminate the wireless tethered connection before transmitting the wireless connection establishment procedure 240.

In some cases, the HMD 205 may determine to maintain the tethered wireless connection with the UE 115-a. For instance, the HMD 205 may determine that the service quality associated with the UE 115-a is higher than any of the candidate APs 215 (e.g., an RSSI value associated with the UE 115-a is greater than any of the RSSI values included in the respective wireless characteristics associated with the candidate APs 215). Additionally, or alternatively, the HMD 205 may determine that the respective service quality associated each of the candidate APs 215 is below a quality threshold. That is, each respective RSSI value associated with of the candidate APs 215 is below an RSSI value threshold. Additionally, or alternatively, the HMD 205 may determine that performing the handover may increase a power expenditure at the HMD 205 above a power expenditure threshold. Additionally, or alternatively, one or more APs 215 may reject the request from the HMD 205 to establish a wireless connection as part of the wireless connection establishment procedure 240. As such, based on any combination of the reasons described herein, the HMD 205 may determine to reject the handover from the UE 115-a. In such examples, the HMD 205 may indicate in the handover response message 235 rejection of the handover request and maintain the tethered wireless connection with the UE 115-a.

In some implementations, the HMD 205 may perform a scanning procedure (such as a second WLAN scanning procedure 225-b) for each of the candidate APs 215 included in the candidate APs indication 230. For example, the difference in geographic location between the UE 115-a and the AP 215 may be great enough (e.g., above a distance threshold) that the service quality associated with each of the APs 215 may be different for the HMD 205 compared to the UE 115-a. As such, the HMD 205 may perform the second WLAN scanning procedure 225-b and determine a service quality (such as an RSSI value) for each of the candidate APs 215 in accordance with the geographic location of the HMD 205. In such implementations, the HMD 205 may use the information collected during the second WLAN scanning procedure 225-b to determine which wireless device to use for communications with the network (e.g., maintain the tethered wireless connection with the UE 115-a or handover the wireless connection to a candidate AP 215).

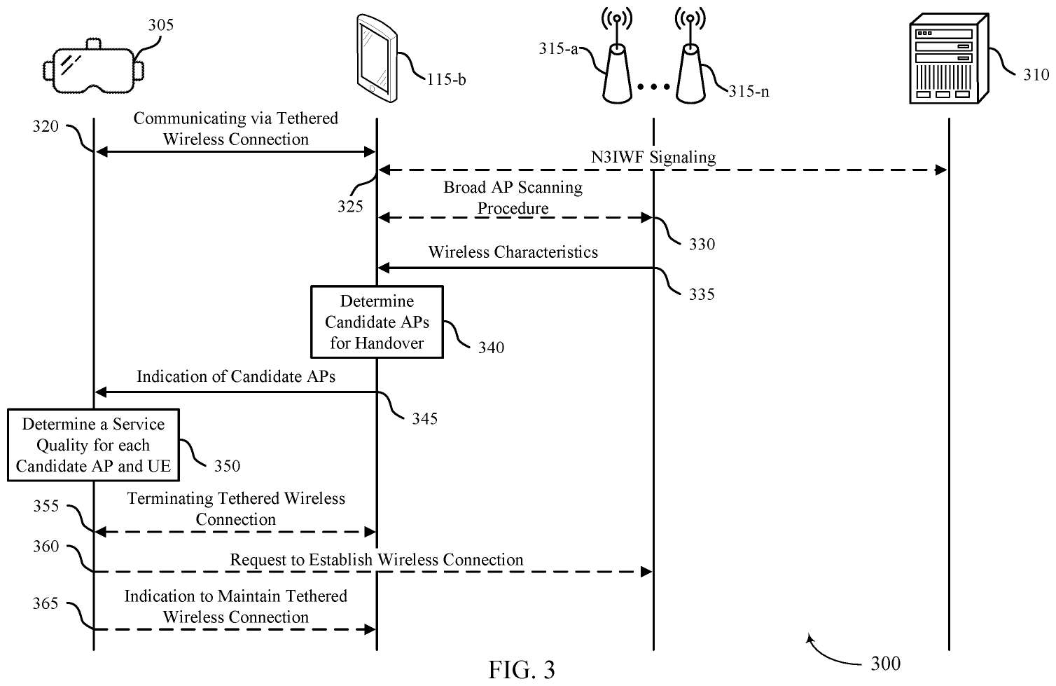

FIG. 3 shows an example of a process flow 300 that supports inter-RAT handover for wireless devices in accordance with one or more aspects of the present disclosure. In some examples, process flow 300 may implement aspects of wireless communications system 100 and 200. Process flow 300 includes a UE 115-b which may be an example of a first wireless device and a UE 115, as described with reference to FIGS. 1 and 2. An HMD 305 may be an example of a second wireless device, an HMD 185, and an HMD 205, as described with reference to FIGS. 1 and 2. APs 315-a through AP 315-n may be an example of APs 190 and APs 215, as described with reference to FIGS. 1 and 2. A core network device may be an example of core network device 210, as described with reference to FIG. 2. Alternative examples of the following may be implemented, where some steps are performed in a different order than described or are not performed at all. In some cases, steps may include additional features not mentioned below, or further steps may be added. In addition, while process flow 300 shows processes between multiple wireless devices, it should be understood that these processes may occur between any quantity of network devices and network device types.

At 320, the UE 115-b may communicate, with a HMD 305 via a tethered wireless connection between the UE 115-b and the HMD 305. In some examples, the tethered wireless connection may be associated with a first type of RAT (such as 5G-NR), the UE 115-b providing connectivity between the HMD 305 and a network.

In some examples, the UE 115-b may determine that communications with the network using the first type of RAT is associated with a QoS parameter below a

QoS parameter. For example, as described with reference to FIG. 2, the UE 115-b and the network may perform one or more signaling measurements (for one or more RRC signals) and determine that the QoS of the connection between the UE 115-b and the network is below a quality threshold. As such, the UE 115-b may obtain an indication of one or more APs 315 associated with a second type of RAT (such as Wi-Fi) and within a range of the UE 115-b.

In some examples, at 325, the UE 115-b may perform N3IWF signaling with the core network device 310 to obtain the indication of the one or more APs 315. For example, the UE 115-b may transmit to the core network device 310, an indication of a geographic location of the UE 115-b. As such, the UE 115-b may receive from the 5GCN the indication of the one or more APs 315 in accordance with the geographic location of the UE 115-b.

In some examples, at 330, the UE 115-b may perform a broad AP scanning procedure to obtain the indication of the one or more APs 315 within geographic range of the UE 115-b. The UE 115-b may perform the broad AP 315 scanning procedure in addition to or alternatively to the N3IWF signaling, at 325.

At 335, the UE 115-b may receive from each AP 315 of the one or more APs 315, respective wireless characteristics. For example, the respective wireless characteristics may each include one or more of an AP 315 frequency, an RSSI value, an SSID, a MAC, and an operating channel bandwidth.

At 340, the UE 115-b may determine one or more candidate APs 315 from the one or more APs 315 for the handover based on the respective wireless characteristics received from each AP 315. For instance, the one or more candidate APs 315 may be a subset of the one or more APs 315 where APs 315 with an associated service quality that is above a threshold are selected as candidate APs 315. Additionally, or alternatively, the UE 115-b may determine the one or more candidate APs 315 based on any combination of the respective wireless characteristics associated with each of the one or more APs 315.

At 335, the UE 115-b may transmit to the HMD 305 an indication of the one or more candidate APs 315 for a handover of the HMD 305 from the UE 115-b to maintain the connectivity between the HMD 305 and the network. The UE 115-b may transmit the indication based on one or more performance parameters associated with the tethered wireless connection. For example, the one or more performance parameters associated with the tethered wireless connection may include a QoS value associated with the tethered wireless connection, where transmitting the indication of the one or more candidate APs 315 for the handover may be based on the QoS value satisfying a threshold value (e.g., being below a quality threshold).

In some examples, the indication of the one or more candidate APs 315 may include the respective wireless characteristics for each of the one or more candidate APs 315 (e.g., received by the UE 115-b, at 335).

In some examples, the indication of the one or more candidate APs 315 includes an ordering of the one or more candidate APs 315 in accordance with a handover priority of each candidate AP 315. The handover priority may be based on the respective wireless characteristics for each of the one or more candidate APs 315. For example, the ordering of the handover priority may be based on a respective RSSI value included in each of the respective wireless characteristics for each of the one or more candidate APs 315.

At 350, the HMD 305 may determine, a QoS associated with communicating with each of the candidate APs 315 and the UE 115-b. For example, the HMD 305 may use the respective wireless characteristics (such as the respective RSSI values) associated with each of the candidate APs 315 included in the indication received, at 345. Additionally, or alternatively, the HMD 305 may perform at a geographic location of the HMD 305, an AP scanning procedure for each of the one or more candidate APs 315 for the handover. In such examples, the HMD 305 may determine a respective service quality (such as respective RSSI values) associated with each of the candidate APs 315 based on the geographic location of the HMD 305 (rather than based on the geographic location of the UE 115-b). As such, the HMD 305 may determine which wireless device may provide a highest quality of service for communicating with the network.

In some examples, the HMD 305 may determine that a first candidate AP 315 of the one or more candidate APs 315 has a highest associated service quality out of the one or more candidate APs 315 and the UE 115-b. In such examples, at 355, the HMD 305 and UE 115-b may terminate the tethered wireless connection based on determining that the first candidate AP 315 of the one or more candidate APs 315 has the highest associated service quality. At 360, the HMD 305 may transmit to the first candidate AP 315, a request to establish a wireless connection providing connectivity between the HMD 305 and the network in accordance with the handover from the UE 115-b.

In some examples, the HMD 305 may determine that the UE 115-b has a highest associated service quality out of the one or more candidate APs 315 and the UE 115-b. In such examples, at 365, the HMD 305 may transmit an indication that the HMD 305 has rejected the handover from the UE 115-b and may maintain the tethered wireless connection with the UE 115-b. As such, the HMD 305 and UE 115-b may maintain the tethered wireless connection in accordance with the indication that the HMD 305 rejects the handover from the UE 115-b.

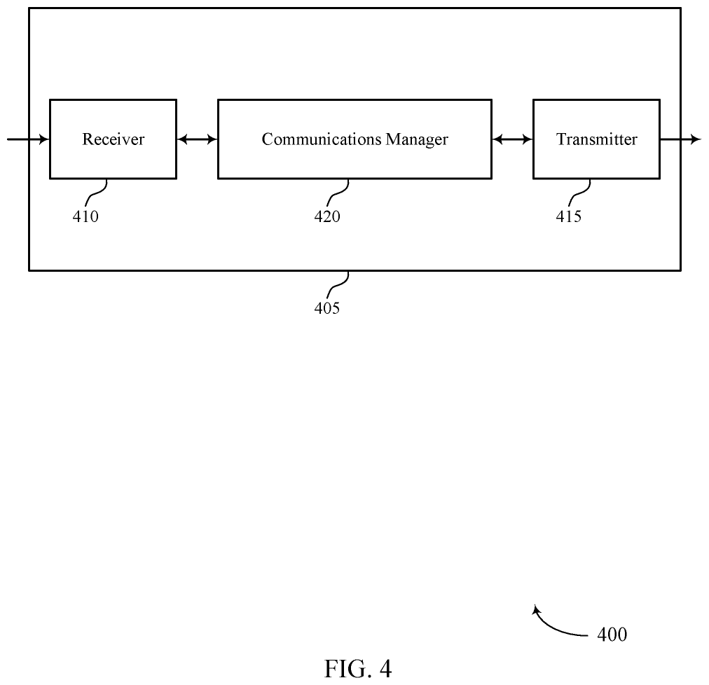

FIG. 4 shows a block diagram 400 of a device 405 that supports inter-RAT handover for wireless devices in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, and the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to inter-RAT handover for wireless devices). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to inter-RAT handover for wireless devices). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of inter-RAT handover for wireless devices as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor. If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for communicating, with a second wireless device via a tethered wireless connection between the first wireless device and the second wireless device, the tethering wireless connection associated with a first type of RAT, the first wireless device providing connectivity between the second wireless device and a network. The communications manager 420 is capable of, configured to, or operable to support a means for obtaining an indication of one or more APs associated with a second type of RAT and within a range of the first wireless device. The communications manager 420 is capable of, configured to, or operable to support a means for transmitting, based on one or more performance parameters associated with the tethered wireless connection, an indication of one or more candidate APs of the one or more APs for a handover of the second wireless device from the first wireless device to maintain the connectivity between the second wireless device and the network.

Additionally, or alternatively, the communications manager 420 may support wireless communications in accordance with examples as disclosed herein. For example, the communications manager 420 is capable of, configured to, or operable to support a means for communicating, with a first wireless device via a tethered wireless connection between the first wireless device and the second wireless device, the tethering wireless connection associated with a first type of RAT, the first wireless device providing connectivity between the second wireless device and a network. The communications manager 420 is capable of, configured to, or operable to support a means for receiving, based on one or more performance parameters associated with the tethered wireless connection, an indication of one or more candidate APs associated with a second type of RAT and within a range of the second wireless device, the one or more candidate APs for a handover of the second wireless device from the first wireless device to maintain the connectivity between the second wireless device and the network.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, and more efficient utilization of communication resources.

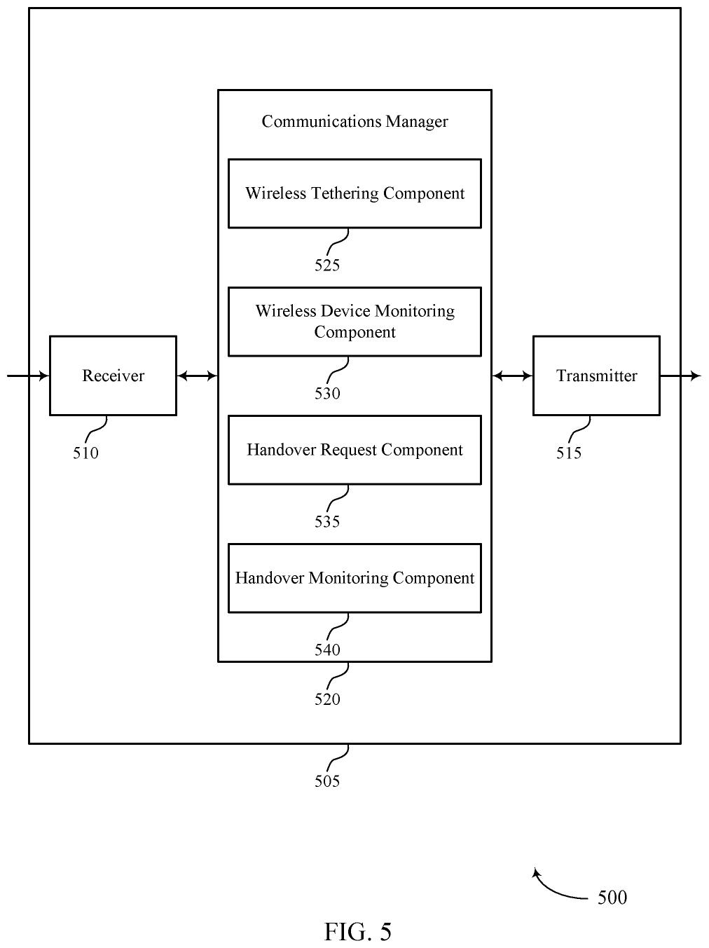

FIG. 5 shows a block diagram 500 of a device 505 that supports inter-RAT handover for wireless devices in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to inter-RAT handover for wireless devices). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to inter-RAT handover for wireless devices). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of inter-RAT handover for wireless devices as described herein. For example, the communications manager 520 may include a wireless tethering component 525, a wireless device monitoring component 530, a handover request component 535, a handover monitoring component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The wireless tethering component 525 is capable of, configured to, or operable to support a means for communicating, with a second wireless device via a tethered wireless connection between the first wireless device and the second wireless device, the tethered wireless connection associated with a first type of RAT, the first wireless device providing connectivity between the second wireless device and a network. The wireless device monitoring component 530 is capable of, configured to, or operable to support a means for obtaining an indication of one or more APs associated with a second type of RAT and within a range of the first wireless device. The handover request component 535 is capable of, configured to, or operable to support a means for transmitting, based on one or more performance parameters associated with the tethered wireless connection, an indication of one or more candidate APs of the one or more APs for a handover of the second wireless device from the first wireless device to maintain the connectivity between the second wireless device and the network.

Additionally, or alternatively, the communications manager 520 may support wireless communications in accordance with examples as disclosed herein. The wireless tethering component 525 is capable of, configured to, or operable to support a means for communicating, with a first wireless device via a tethered wireless connection between the first wireless device and the second wireless device, the tethered wireless connection associated with a first type of RAT, the first wireless device providing connectivity between the second wireless device and a network. The handover monitoring component 540 is capable of, configured to, or operable to support a means for receiving, based on one or more performance parameters associated with the tethered wireless connection, an indication of one or more candidate APs associated with a second type of RAT and within a range of the second wireless device, the one or more candidate APs for a handover of the second wireless device from the first wireless device to maintain the connectivity between the second wireless device and the network.

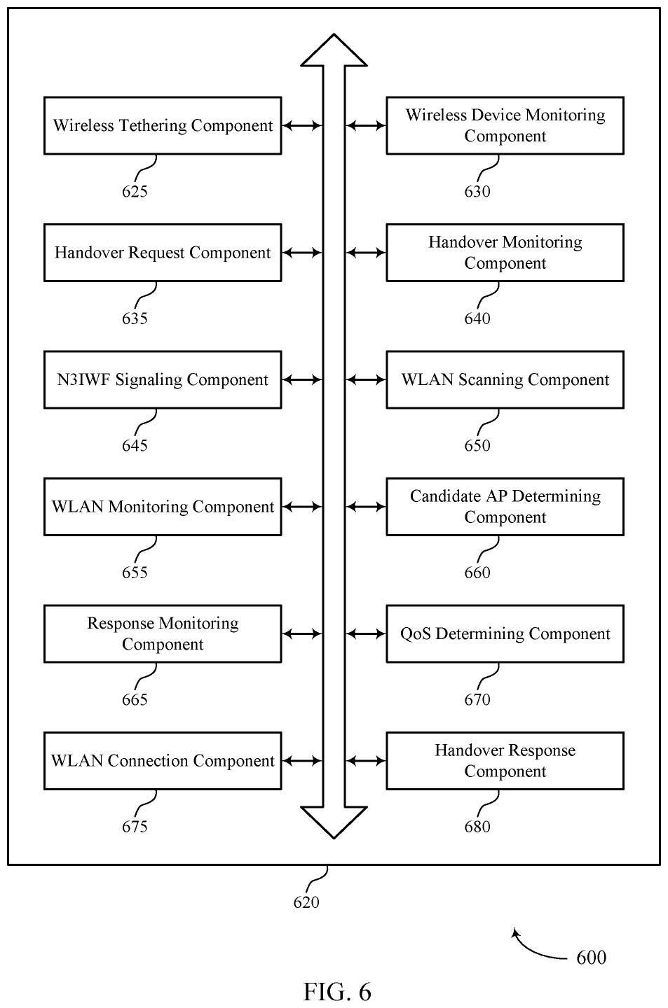

FIG. 6 shows a block diagram 600 of a communications manager 620 that supports inter-RAT handover for wireless devices in accordance with one or more aspects of the present disclosure. The communications manager 620 may be an example of aspects of a communications manager 420, a communications manager 520, or both, as described herein. The communications manager 620, or various components thereof, may be an example of means for performing various aspects of inter-RAT handover for wireless devices as described herein. For example, the communications manager 620 may include a wireless tethering component 625, a wireless device monitoring component 630, a handover request component 635, a handover monitoring component 640, a N3IWF signaling component 645, a WLAN scanning component 650, a WLAN monitoring component 655, a candidate AP determining component 660, a response monitoring component 665, a QoS determining component 670, a WLAN connection component 675, a handover response component 680, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The wireless tethering component 625 is capable of, configured to, or operable to support a means for communicating, with a second wireless device via a tethered wireless connection between the first wireless device and the second wireless device, the tethered wireless connection associated with a first type of RAT, the first wireless device providing connectivity between the second wireless device and a network. The wireless device monitoring component 630 is capable of, configured to, or operable to support a means for obtaining an indication of one or more APs associated with a second type of RAT and within a range of the first wireless device. The handover request component 635 is capable of, configured to, or operable to support a means for transmitting, based on one or more performance parameters associated with the tethered wireless connection, an indication of one or more candidate APs of the one or more APs for a handover of the second wireless device from the first wireless device to maintain the connectivity between the second wireless device and the network.

In some examples, to support obtaining the indication of the one or more APs associated with the second type of RAT, the N3IWF signaling component 645 is capable of, configured to, or operable to support a means for transmitting, to the network, an indication of a geographic location of the first wireless device. In some examples, to support obtaining the indication of the one or more APs associated with the second type of RAT, the N3IWF signaling component 645 is capable of, configured to, or operable to support a means for receiving. from the network, the indication of the one or more APs in accordance with the geographic location of the first wireless device.

In some examples, the network includes a N3IWF and the first wireless device communicates with the network via N3IWF signaling.

In some examples, to support obtaining the indication of the one or more APs associated with the second type of RAT, the WLAN scanning component 650 is capable of, configured to, or operable to support a means for performing an AP scanning procedure identifying the one or more APs.

In some examples, the WLAN monitoring component 655 is capable of, configured to, or operable to support a means for receiving, from each AP of the one or more APs, respective wireless characteristics. In some examples, the candidate AP determining component 660 is capable of, configured to, or operable to support a means for determining the one or more candidate APs of the one or more APs for the handover are based on the respective wireless characteristics received from each AP.

In some examples, to support transmitting the indication of the one or more candidate APs for the handover, the handover request component 635 is capable of, configured to, or operable to support a means for transmitting the respective wireless characteristics for each of the one or more candidate APs.

In some examples, the indication of the one or more candidate APs includes an ordering of the one or more candidate APs in accordance with a handover priority of each candidate AP of the one or more candidate APs. In some examples, the handover priority is based at least in part on the respective wireless characteristics for each of the one or more candidate APs.

In some examples, the ordering of the handover priority is based on a respective RSSI value included in each of the respective wireless characteristics for each of the one or more candidate APs.

In some examples, each respective wireless characteristics received from each AP includes one or more of an AP frequency, a RSSI value, a SSID, a MAC address, and an operating channel bandwidth.

In some examples, the wireless tethering component 625 is capable of, configured to, or operable to support a means for terminating the tethered wireless connection in accordance with transmitting the indication of the one or more candidate APs for the handover from the first wireless device.

In some examples, the response monitoring component 665 is capable of, configured to, or operable to support a means for receiving an indication that the second wireless device rejects the handover from the first wireless device. In some examples, the wireless tethering component 625 is capable of, configured to, or operable to support a means for maintaining the tethered wireless connection in accordance with the indication that the second wireless device rejects the handover from the first wireless device.

In some examples, the one or more performance parameters associated with the tethered wireless connection include a quality of service value associated with the tethered wireless connection. In some examples, transmitting the indication of the one or more candidate APs for the handover is based on the quality of service value satisfying a threshold value.

In some examples, the first wireless device is a UE, and the second wireless device is a HMD device, augmented reality glasses, or virtual reality glasses.

In some examples, the first type of RAT is a cellular RAT, and the second type of RAT is a wireless local area network RAT.

Additionally, or alternatively, the communications manager 620 may support wireless communications in accordance with examples as disclosed herein. In some examples, the wireless tethering component 625 is capable of, configured to, or operable to support a means for communicating, with a first wireless device via a tethered wireless connection between the first wireless device and the second wireless device, the tethered wireless connection associated with a first type of RAT, the first wireless device providing connectivity between the second wireless device and a network. The handover monitoring component 640 is capable of, configured to, or operable to support a means for receiving, based on one or more performance parameters associated with the tethered wireless connection, an indication of one or more candidate APs associated with a second type of RAT and within a range of the second wireless device, the one or more candidate APs for a handover of the second wireless device from the first wireless device to maintain the connectivity between the second wireless device and the network.

In some examples, to support receiving the indication of the one or more candidate APs for the handover, the handover monitoring component 640 is capable of, configured to, or operable to support a means for receiving respective wireless characteristics for each of the one or more candidate APs.

In some examples, the indication of the one or more candidate APs includes an ordering of the one or more candidate APs in accordance with a handover priority of each candidate AP of the one or more candidate APs. In some examples, the handover priority is based at least in part on the respective wireless characteristics for each of the one or more candidate APs.

In some examples, each respective wireless characteristics received from each AP includes one or more of an AP frequency, a RSSI value, a SSID, a MAC address, and an operating channel bandwidth.

In some examples, the WLAN scanning component 650 is capable of, configured to, or operable to support a means for performing, at a geographic location of the second wireless device, an AP scanning procedure for each of the one or more candidate APs for the handover. In some examples, the QoS determining component 670 is capable of, configured to, or operable to support a means for determining a respective service quality associated with each of the one or more candidate APs based on performing the AP scanning procedure.

In some examples, the QoS determining component 670 is capable of, configured to, or operable to support a means for determining that a first candidate AP of the one or more candidate APs has a highest associated service quality out of the one or more candidate APs and the first wireless device. In some examples, the wireless tethering component 625 is capable of, configured to, or operable to support a means for terminating the tethered wireless connection based on determining that the first candidate AP of the one or more candidate APs has the highest associated service quality. In some examples, the WLAN connection component 675 is capable of, configured to, or operable to support a means for transmitting, to the first candidate AP, a request to establish a wireless connection providing connectivity between the second wireless device and the network in accordance with the handover from the first wireless device.

In some examples, the handover response component 680 is capable of, configured to, or operable to support a means for transmitting, to the first wireless device, an indication that the second wireless device has rejected the handover from the first wireless device and will maintain the tethered wireless connection with the first wireless device. In some examples, the wireless tethering component 625 is capable of, configured to, or operable to support a means for maintaining the tethered wireless connection in accordance with the indication that the second wireless device rejects the handover from the first wireless device.

In some examples, the one or more performance parameters associated with the tethered wireless connection include a quality of service value associated with the tethered wireless connection. In some examples, transmitting the indication of the one or more candidate APs for the handover is based on the quality of service value satisfying a threshold value.

In some examples, the first wireless device is a UE, and the second wireless device is a HMD device, augmented reality glasses, or virtual reality glasses.

In some examples, the first type of RAT is a cellular RAT, and the second type of RAT is a wireless local area network RAT.

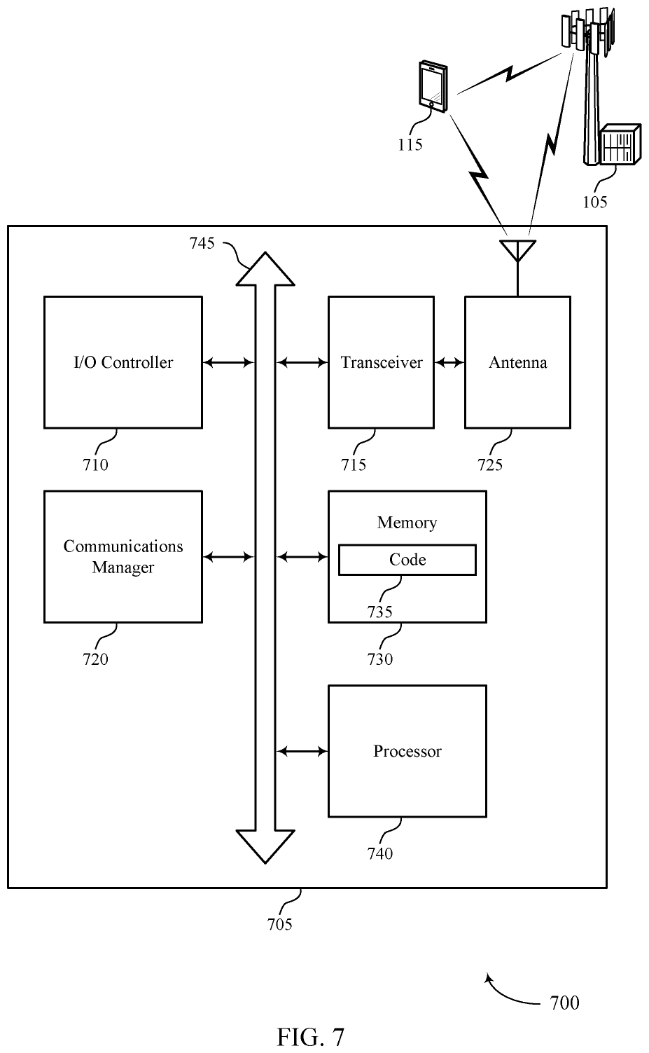

FIG. 7 shows a diagram of a system 700 including a device 705 that supports inter-RAT handover for wireless devices in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable code 735 including instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may contain, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting inter-RAT handover for wireless devices). For example, the device 705 or a component of the device 705 may include at least one processor 740 and at least one memory 730 coupled with or to the at least one processor 740, the at least one processor 740 and at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions herein.

The communications manager 720 may support wireless communications in accordance with examples as disclosed herein. For example, the communications manager 720 is capable of, configured to, or operable to support a means for communicating, with a second wireless device via a tethered wireless connection between the first wireless device and the second wireless device, the tethering wireless connection associated with a first type of RAT, the first wireless device providing connectivity between the second wireless device and a network. The communications manager 720 is capable of, configured to, or operable to support a means for obtaining an indication of one or more APs associated with a second type of RAT and within a range of the first wireless device. The communications manager 720 is capable of, configured to, or operable to support a means for transmitting, based on one or more performance parameters associated with the tethered wireless connection, an indication of one or more candidate APs of the one or more APs for a handover of the second wireless device from the first wireless device to maintain the connectivity between the second wireless device and the network.

Additionally, or alternatively, the communications manager 720 may support wireless communications in accordance with examples as disclosed herein. For example, the communications manager 720 is capable of, configured to, or operable to support a means for communicating, with a first wireless device via a tethered wireless connection between the first wireless device and the second wireless device, the tethering wireless connection associated with a first type of RAT, the first wireless device providing connectivity between the second wireless device and a network. The communications manager 720 is capable of, configured to, or operable to support a means for receiving, based on one or more performance parameters associated with the tethered wireless connection, an indication of one or more candidate APs associated with a second type of RAT and within a range of the second wireless device, the one or more candidate APs for a handover of the second wireless device from the first wireless device to maintain the connectivity between the second wireless device and the network.

By including or configuring the communications manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of inter-RAT handover for wireless devices as described herein, or the at least one processor 740 and the at least one memory 730 may be otherwise configured to, individually or collectively, perform or support such operations.

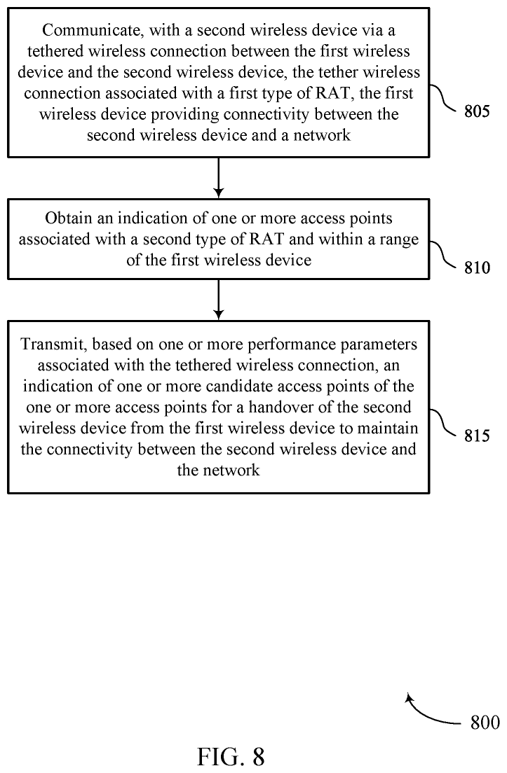

FIG. 8 shows a flowchart illustrating a method 800 that supports inter-RAT handover for wireless devices in accordance with aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include communicating, with a second wireless device via a tethered wireless connection between the first wireless device and the second wireless device, the tethered wireless connection associated with a first type of RAT, the first wireless device providing connectivity between the second wireless device and a network. The operations of block 805 may be performed in accordance with examples as disclosed herein, such as at 320 of FIG. 3. The tethered wireless connection may allow for the transmission of the candidate APs Indication 230 and the handover response message 235, as illustrated in FIG. 2. In some examples, aspects of the operations of 805 may be performed by a wireless tethering component 625 as described with reference to FIG. 6.

At 810, the method may include obtaining an indication of one or more APs associated with a second type of RAT and within a range of the first wireless device. The operations of block 810 may be performed in accordance with examples as disclosed herein, such as the N3IWF signaling 220 of FIG. 2, the N3IWF signaling at 325 of FIG. 3, or the broad AP scanning procedure at 330 of FIG. 3. In some examples, aspects of the operations of 810 may be performed by a wireless device monitoring component 630 as described with reference to FIG. 6.

At 815, the method may include transmitting, based on one or more performance parameters associated with the tethered wireless connection, an indication of one or more candidate APs of the one or more APs for a handover of the second wireless device from the first wireless device to maintain the connectivity between the second wireless device and the network. The operations of block 815 may be performed in accordance with examples as disclosed herein, such as the candidate APs indication 230 of FIG. 2 or the indication of candidate APs, at 345 of FIG. 3. In some examples, aspects of the operations of 815 may be performed by a handover request component 635 as described with reference to FIG. 6.

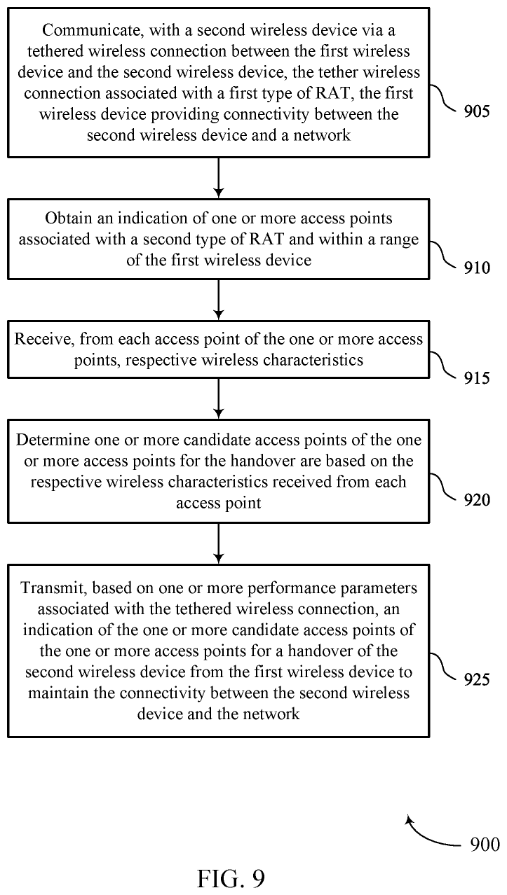

FIG. 9 shows a flowchart illustrating a method 900 that supports inter-RAT handover for wireless devices in accordance with aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include communicating, with a second wireless device via a tethered wireless connection between the first wireless device and the second wireless device, the tethered wireless connection associated with a first type of RAT, the first wireless device providing connectivity between the second wireless device and a network. The operations of block 905 may be performed in accordance with examples as disclosed herein such as at 320 of FIG. 3. The tethered wireless connection may allow for the transmission of the candidate APs Indication 230 and the handover response message 235, as illustrated in FIG. 2. In some examples, aspects of the operations of 905 may be performed by a wireless tethering component 625 as described with reference to FIG. 6.

At 910, the method may include obtaining an indication of one or more APs associated with a second type of RAT and within a range of the first wireless device. The operations of block 910 may be performed in accordance with examples as disclosed herein, such as the N3IWF signaling 220 of FIG. 2, the N3IWF signaling at 325 of FIG. 3, or the broad AP scanning procedure at 330 of FIG. 3. In some examples, aspects of the operations of 910 may be performed by a wireless device monitoring component 630 as described with reference to FIG. 6.

At 915, the method may include receiving, from each AP of the one or more APs, respective wireless characteristics. The operations of block 915 may be performed in accordance with examples as disclosed herein, such as the WLAN scanning procedure 225-a of FIG. 2 or receiving the wireless characteristics, at 335 of FIG. 3. In some examples, aspects of the operations of 915 may be performed by a WLAN monitoring component 655 as described with reference to FIG. 6.

At 920, the method may include determining the one or more candidate APs of the one or more APs for the handover are based on the respective wireless characteristics received from each AP. The operations of block 920 may be performed in accordance with examples as disclosed herein, such as at 340 of FIG. 3. In some examples, aspects of the operations of 920 may be performed by a candidate AP determining component 660 as described with reference to FIG. 6.

At 925, the method may include transmitting, based on one or more performance parameters associated with the tethered wireless connection, an indication of one or more candidate APs of the one or more APs for a handover of the second wireless device from the first wireless device to maintain the connectivity between the second wireless device and the network. The operations of block 925 may be performed in accordance with examples as disclosed herein, such as the candidate APs indication 230 of FIG. 2 or the indication of candidate APs, at 345 of FIG. 3. In some examples, aspects of the operations of 925 may be performed by a handover request component 635 as described with reference to FIG. 6.

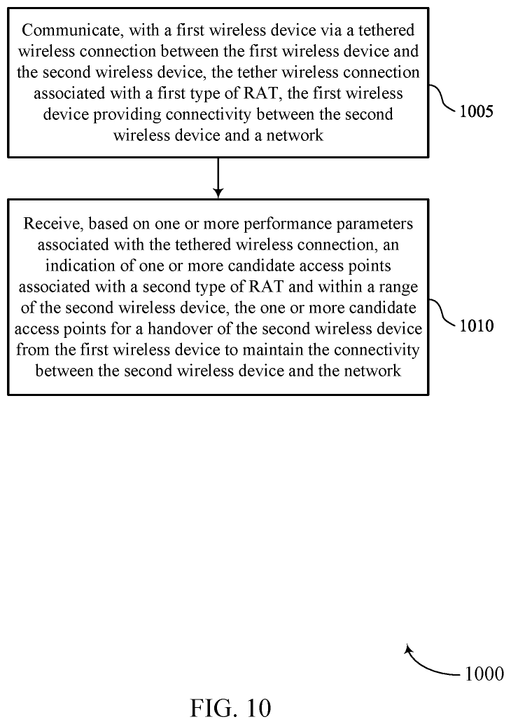

FIG. 10 shows a flowchart illustrating a method 1000 that supports inter-RAT handover for wireless devices in accordance with aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include communicating, with a first wireless device via a tethered wireless connection between the first wireless device and the second wireless device, the tethered wireless connection associated with a first type of RAT, the first wireless device providing connectivity between the second wireless device and a network. The operations of block 1005 may be performed in accordance with examples as disclosed herein, such as at 320 of FIG. 3. The tethered wireless connection may allow for the transmission of the candidate APs Indication 230 and the handover response message 235, as illustrated in FIG. 2. In some examples, aspects of the operations of 1005 may be performed by a wireless tethering component 625 as described with reference to FIG. 6.

At 1010, the method may include receiving, based on one or more performance parameters associated with the tethered wireless connection, an indication of one or more candidate APs associated with a second type of RAT and within a range of the second wireless device, the one or more candidate APs for a handover of the second wireless device from the first wireless device to maintain the connectivity between the second wireless device and the network. The operations of block 1010 may be performed in accordance with examples as disclosed herein, such as the candidate APs indication 230 of FIG. 2 or the indication of candidate APs, at 345 of FIG. 3. In some examples, aspects of the operations of 1010 may be performed by a handover monitoring component 640 as described with reference to FIG. 6.

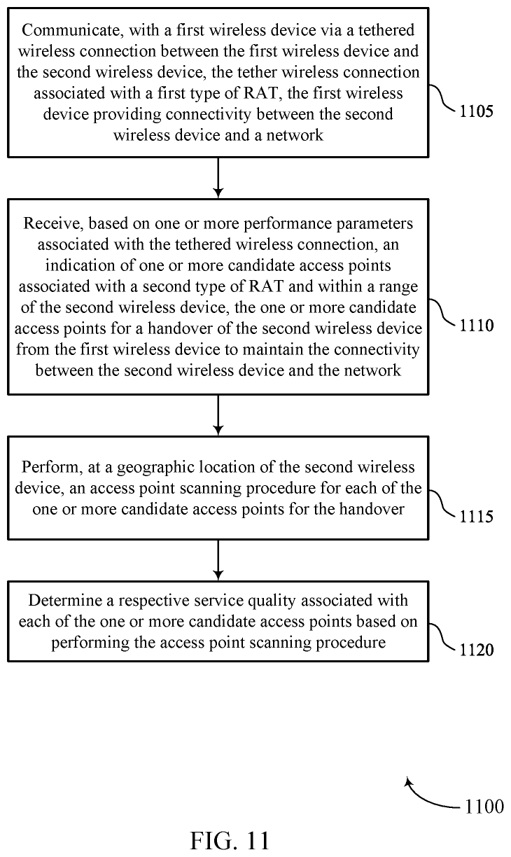

FIG. 11 shows a flowchart illustrating a method 1100 that supports inter-RAT handover for wireless devices in accordance with aspects of the present disclosure. The operations of the method 1100 may be implemented by a UE or its components as described herein. For example, the operations of the method 1100 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1105, the method may include communicating, with a first wireless device via a tethered wireless connection between the first wireless device and the second wireless device, the tethered wireless connection associated with a first type of RAT, the first wireless device providing connectivity between the second wireless device and a network. The operations of block 1105 may be performed in accordance with examples as disclosed herein, such as at 320 of FIG. 3. The tethered wireless connection may allow for the transmission of the candidate APs Indication 230 and the handover response message 235, as illustrated in FIG. 2. In some examples, aspects of the operations of 1105 may be performed by a wireless tethering component 625 as described with reference to FIG. 6.

At 1110, the method may include receiving, based on one or more performance parameters associated with the tethered wireless connection, an indication of one or more candidate APs associated with a second type of RAT and within a range of the second wireless device, the one or more candidate APs for a handover of the second wireless device from the first wireless device to maintain the connectivity between the second wireless device and the network. The operations of block 1110 may be performed in accordance with examples as disclosed herein, such as the candidate APs indication 230 of FIG. 2 or the indication of candidate APs, at 345 of FIG. 3. In some examples, aspects of the operations of 1110 may be performed by a handover monitoring component 640 as described with reference to FIG. 6.

At 1115, the method may include performing, at a geographic location of the second wireless device, an AP scanning procedure for each of the one or more candidate APs for the handover. The operations of block 1115 may be performed in accordance with examples as disclosed herein, such as the WLAN scanning procedure 225-b as illustrated in FIG. 2 or the determination of a service quality value for each of the candidate APs and the UE, at 350 of FIG. 3. In some examples, aspects of the operations of 1115 may be performed by a WLAN scanning component 650 as described with reference to FIG. 6.

At 1120, the method may include determining a respective service quality associated with each of the one or more candidate APs based on performing the AP scanning procedure. The operations of block 1120 may be performed in accordance with examples as disclosed herein, such as the WLAN scanning procedure 225-b as illustrated in FIG. 2 or the determination of a service quality value for each of the candidate APs and the UE, at 350 of FIG. 3. In some examples, aspects of the operations of 1120 may be performed by a QoS determining component 670 as described with reference to FIG. 6.

The following provides an overview of aspects of the present disclosure:

Aspect 1: A method for wireless communications, at a first wireless device, comprising: communicating, with a second wireless device via a tethered wireless connection between the first wireless device and the second wireless device, the tethered wireless connection associated with a first type of RAT, the first wireless device providing connectivity between the second wireless device and a network; obtaining an indication of one or more APs associated with a second type of RAT and within a range of the first wireless device; and transmitting, based at least in part on one or more performance parameters associated with the tethered wireless connection, an indication of one or more candidate APs of the one or more APs for a handover of the second wireless device from the first wireless device to maintain the connectivity between the second wireless device and the network.

Aspect 2: The method of aspect 1, wherein obtaining the indication of the one or more APs associated with the second type of RAT comprises: transmitting, to the network, an indication of a geographic location of the first wireless device; and receiving, from the network, the indication of the one or more APs in accordance with the geographic location of the first wireless device.

Aspect 3: The method of aspect 2, wherein the network comprises a N3IWF and the first wireless device communicates with the network via N3IWF signaling.

Aspect 4: The method of any of aspects 1 through 3, wherein obtaining the indication of the one or more APs associated with the second type of RAT comprises: performing an AP scanning procedure identifying the one or more APs.

Aspect 5: The method of any of aspects 1 through 4, further comprising: receiving, from each AP of the one or more APs, respective wireless characteristics; and determining the one or more candidate APs of the one or more APs for the handover are based at least in part on the respective wireless characteristics received from each AP.

Aspect 6: The method of aspect 5, wherein transmitting the indication of the one or more candidate APs for the handover comprises: transmitting the respective wireless characteristics for each of the one or more candidate APs.

Aspect 7: The method of any of aspects 5 through 6, wherein the indication of the one or more candidate APs includes an ordering of the one or more candidate APs in accordance with a handover priority of each candidate AP of the one or more candidate APs, and the handover priority is based at least in part the respective wireless characteristics for each of the one or more candidate APs.

Aspect 8: The method of aspect 7, wherein the ordering of the handover priority is based at least in part on a respective RSSI value comprised in each of the respective wireless characteristics for each of the one or more candidate APs.

Aspect 9: The method of any of aspects 5 through 8, wherein each respective wireless characteristics received from each AP comprises one or more of an AP frequency, a RSSI value, a SSID, a MAC address, and an operating channel bandwidth.

Aspect 10: The method of any of aspects 1 through 9, further comprising: terminating the tethered wireless connection in accordance with transmitting the indication of the one or more candidate APs for the handover from the first wireless device.

Aspect 11: The method of any of aspects 1 through 10, further comprising: receiving an indication that the second wireless device rejects the handover from the first wireless device; and maintaining the tethered wireless connection in accordance with the indication that the second wireless device rejects the handover from the first wireless device.

Aspect 12: The method of any of aspects 1 through 11, wherein the one or more performance parameters associated with the tethered wireless connection comprise a quality of service value associated with the tethered wireless connection, and transmitting the indication of the one or more candidate APs for the handover is based at least in part on the quality of service value satisfying a threshold value.

Aspect 13: The method of any of aspects 1 through 12, wherein the first wireless device is a UE, and the second wireless device is a HMD device, augmented reality glasses, or virtual reality glasses.

Aspect 14: The method of any of aspects 1 through 13, wherein the first type of RAT is a cellular RAT and the second type of RAT is a wireless local area network RAT.

Aspect 15: A method for wireless communications, at a second wireless device, comprising: communicating, with a first wireless device via a tethered wireless connection between the first wireless device and the second wireless device, the tethered wireless connection associated with a first type of RAT, the first wireless device providing connectivity between the second wireless device and a network; and receiving, based at least in part on one or more performance parameters associated with the tethered wireless connection, an indication of one or more candidate APs associated with a second type of RAT and within a range of the second wireless device, the one or more candidate APs for a handover of the second wireless device from the first wireless device to maintain the connectivity between the second wireless device and the network.

Aspect 16: The method of aspect 15, wherein receiving the indication of the one or more candidate APs for the handover comprises: receiving respective wireless characteristics for each of the one or more candidate APs.

Aspect 17: The method of aspect 16, wherein the indication of the one or more candidate APs includes an ordering of the one or more candidate APs in accordance with a handover priority of each candidate AP of the one or more candidate APs, and the handover priority is based at least in part the respective wireless characteristics for each of the one or more candidate APs.

Aspect 18: The method of any of aspects 16 through 17, wherein each respective wireless characteristics received from each AP comprises one or more of an AP frequency, a RSSI value, a SSID, a MAC address, and an operating channel bandwidth.

Aspect 19: The method of any of aspects 15 through 18, further comprising: performing, at a geographic location of the second wireless device, an AP scanning procedure for each of the one or more candidate APs for the handover determining a respective service quality associated with each of the one or more candidate APs based at least in part on performing the AP scanning procedure.

Aspect 20: The method of any of aspects 15 through 19, further comprising: determining that a first candidate AP of the one or more candidate APs has a highest associated service quality out of the one or more candidate APs and the first wireless device; terminating the tethered wireless connection based at least in part on determining that the first candidate AP of the one or more candidate APs has the highest associated service quality; and transmitting, to the first candidate AP, a request to establish a wireless connection providing connectivity between the second wireless device and the network in accordance with the handover from the first wireless device.

Aspect 21: The method of any of aspects 15 through 20, further comprising: transmitting, to the first wireless device, an indication that the second wireless device has rejected the handover from the first wireless device and will maintain the tethered wireless connection with the first wireless device; and maintaining the tethered wireless connection in accordance with the indication that the second wireless device rejects the handover from the first wireless device.

Aspect 22: The method of any of aspects 15 through 21, wherein the one or more performance parameters associated with the tethered wireless connection comprise a quality of service value associated with the tethered wireless connection, and transmitting the indication of the one or more candidate APs for the handover is based at least in part on the quality of service value satisfying a threshold value.

Aspect 23: The method of any of aspects 15 through 22, wherein the first wireless device is a UE, and the second wireless device is a HMD device, augmented reality glasses, or virtual reality glasses.

Aspect 24: The method of any of aspects 15 through 23, wherein the first type of RAT is a cellular RAT and the second type of RAT is a wireless local area network RAT.

Aspect 25: A first wireless device for wireless communications, comprising one or more memories storing processor-executable code, and one or more processors coupled with the one or more memories and individually or collectively operable to execute the code to cause the first wireless device to perform a method of any of aspects 1 through 14.

Aspect 26: A first wireless device for wireless communications, comprising at least one means for performing a method of any of aspects 1 through 14.

Aspect 27: A non-transitory computer-readable medium storing code for wireless communications, the code comprising instructions executable by a processor to perform a method of any of aspects 1 through 14.

Aspect 28: A second wireless device for wireless communications, comprising one or more memories storing processor-executable code, and one or more processors coupled with the one or more memories and individually or collectively operable to execute the code to cause the second wireless device to perform a method of any of aspects 15 through 24.

Aspect 29: A second wireless device for wireless communications, comprising at least one means for performing a method of any of aspects 15 through 24.

Aspect 30: A non-transitory computer-readable medium storing code for wireless communications, the code comprising instructions executable by a processor to perform a method of any of aspects 15 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings. describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless device, comprising:
one or more memories storing processor-executable code; and
one or more processors coupled with the one or more memories and individually or collectively operable to execute the code to cause the first wireless device to:
communicate, with a second wireless device via a tethered wireless connection between the first wireless device and the second wireless device, the tethered wireless connection associated with a first type of radio access technology (RAT), the first wireless device providing connectivity between the second wireless device and a network;
obtain an indication of one or more access points associated with a second type of RAT and within a range of the first wireless device; and
transmit, based at least in part on one or more performance parameters associated with the tethered wireless connection, an indication of one or more candidate access points of the one or more access points for a handover of the second wireless device from the first wireless device to maintain the connectivity between the second wireless device and the network.

2. The first wireless device of claim 1, wherein, to obtain the indication of the one or more access points associated with the second type of RAT, the one or more processors are individually or collectively operable to execute the code to cause the first wireless device to:
transmit, to the network, an indication of a geographic location of the first wireless device; and
receive, from the network, the indication of the one or more access points in accordance with the geographic location of the first wireless device.

3. The first wireless device of claim 2, wherein the network comprises a non-3GPP inter working function (N3IWF) and the first wireless device communicates with the network via N3IWF signaling.

4. The first wireless device of claim 1, wherein, to obtain the indication of the one or more access points associated with the second type of RAT, the one or more processors are individually or collectively operable to execute the code to cause the first wireless device to:
perform an access point scanning procedure identifying the one or more access points.

5. The first wireless device of claim 1, wherein the one or more processors are individually or collectively further operable to execute the code to cause the first wireless device to:
receive, from each access point of the one or more access points, respective wireless characteristics; and
determine the one or more candidate access points of the one or more access points for the handover are based at least in part on the respective wireless characteristics received from each access point.

6. The first wireless device of claim 5, wherein, to transmit the indication of the one or more candidate access points for the handover, the one or more processors are individually or collectively operable to execute the code to cause the first wireless device to:
transmit the respective wireless characteristics for each of the one or more candidate access points.

7. The first wireless device of claim 5, wherein the indication of the one or more candidate access points includes an ordering of the one or more candidate access points in accordance with a handover priority of each candidate access point of the one or more candidate access points, and wherein the handover priority is based at least in part on the respective wireless characteristics for each of the one or more candidate access points.

8. The first wireless device of claim 7, wherein the ordering of the handover priority is based at least in part on a respective received signal strength indicator value comprised in each of the respective wireless characteristics for each of the one or more candidate access points.

9. The first wireless device of claim 5, wherein each respective wireless characteristics received from each access point comprises one or more of an access point frequency, a received signal strength indicator value, a service set identifier, a medium access control address, and an operating channel bandwidth.

10. The first wireless device of claim 1, wherein the one or more processors are individually or collectively further operable to execute the code to cause the first wireless device to:
terminate the tethered wireless connection in accordance with transmitting the indication of the one or more candidate access points for the handover from the first wireless device.

11. The first wireless device of claim 1, wherein the one or more processors are individually or collectively further operable to execute the code to cause the first wireless device to:
receive an indication that the second wireless device rejects the handover from the first wireless device; and
maintain the tethered wireless connection in accordance with the indication that the second wireless device rejects the handover from the first wireless device.

12. The first wireless device of claim 1, wherein the one or more performance parameters associated with the tethered wireless connection comprise a quality of service value associated with the tethered wireless connection, and wherein to transmit the indication of the one or more candidate access points for the handover is based at least in part on the quality of service value satisfying a threshold value.

13. The first wireless device of claim 1, wherein the first wireless device is a user equipment (UE), and the second wireless device is a head-mounted display (HMD) device, augmented reality glasses, or virtual reality glasses.

14. The first wireless device of claim 1, wherein the first type of RAT is a cellular RAT and the second type of RAT is a wireless local area network RAT.

15. A second wireless device, comprising:
one or more memories storing processor-executable code; and
one or more processors coupled with the one or more memories and individually or collectively operable to execute the code to cause the second wireless device to:
communicate, with a first wireless device via a tethered wireless connection between the first wireless device and the second wireless device, the tethered wireless connection associated with a first type of radio access technology (RAT), the first wireless device providing connectivity between the second wireless device and a network; and
receive, based at least in part on one or more performance parameters associated with the tethered wireless connection, an indication of one or more candidate access points associated with a second type of RAT and within a range of the second wireless device, the one or more candidate access points for a handover of the second wireless device from the first wireless device to maintain the connectivity between the second wireless device and the network.

16. The second wireless device of claim 15, wherein, to receive the indication of the one or more candidate access points for the handover, the one or more processors are individually or collectively operable to execute the code to cause the second wireless device to:
receive respective wireless characteristics for each of the one or more candidate access points.

17. The second wireless device of claim 16, wherein the indication of the one or more candidate access points includes an ordering of the one or more candidate access points in accordance with a handover priority of each candidate access point of the one or more candidate access points, and wherein the handover priority is based at least in part on the respective wireless characteristics for each of the one or more candidate access points.

18. The second wireless device of claim 16, wherein each respective wireless characteristics received from each access point comprises one or more of an access point frequency, a received signal strength indicator value, a service set identifier, a medium access control address, and an operating channel bandwidth.

19. The second wireless device of claim 15, wherein the one or more processors are individually or collectively further operable to execute the code to cause the second wireless device to:
perform, at a geographic location of the second wireless device, an access point scanning procedure for each of the one or more candidate access points for the handover; and
determine a respective service quality associated with each of the one or more candidate access points based at least in part on performing the access point scanning procedure.

20. The second wireless device of claim 15, wherein the one or more processors are individually or collectively further operable to execute the code to cause the second wireless device to:
determine that a first candidate access point of the one or more candidate access points has a highest associated service quality out of the one or more candidate access points and the first wireless device;
terminate the tethered wireless connection based at least in part on determining that the first candidate access point of the one or more candidate access points has the highest associated service quality; and
transmit, to the first candidate access point, a request to establish a wireless connection providing connectivity between the second wireless device and the network in accordance with the handover from the first wireless device.

21. The second wireless device of claim 15, wherein the one or more processors are individually or collectively further operable to execute the code to cause the second wireless device to:
transmit, to the first wireless device, an indication that the second wireless device has rejected the handover from the first wireless device and will maintain the tethered wireless connection with the first wireless device; and
maintain the tethered wireless connection in accordance with the indication that the second wireless device rejects the handover from the first wireless device.

22. The second wireless device of claim 15, wherein the one or more performance parameters associated with the tethered wireless connection comprise a quality of service value associated with the tethered wireless connection, and wherein to receive the indication of the one or more candidate access points for the handover is based at least in part on the quality of service value satisfying a threshold value.

23. The second wireless device of claim 15, wherein the first wireless device is a user equipment (UE), and the second wireless device is a head-mounted display (HMD) device, augmented reality glasses, or virtual reality glasses.

24. The second wireless device of claim 15, wherein the first type of RAT is a cellular RAT and the second type of RAT is a wireless local area network RAT.

25. A method for wireless communications, at a first wireless device, comprising:
communicating, with a second wireless device via a tethered wireless connection between the first wireless device and the second wireless device, the tethered wireless connection associated with a first type of radio access technology (RAT), the first wireless device providing connectivity between the second wireless device and a network;
obtaining an indication of one or more access points associated with a second type of RAT and within a range of the first wireless device; and
transmitting, based at least in part on one or more performance parameters associated with the tethered wireless connection, an indication of one or more candidate access points of the one or more access points for a handover of the second wireless device from the first wireless device to maintain the connectivity between the second wireless device and the network.

26. The method of claim 25, wherein obtaining the indication of the one or more access points associated with the second type of RAT comprises:
transmitting, to the network, an indication of a geographic location of the first wireless device; and
receiving, from the network, the indication of the one or more access points in accordance with the geographic location of the first wireless device.

27. The method of claim 26, wherein the network comprises a non-3GPP inter working function (N3IWF) and the first wireless device communicates with the network via N3IWF signaling.

28. A method for wireless communications, at a second wireless device, comprising:
communicating, with a first wireless device via a tethered wireless connection between the first wireless device and the second wireless device, the tethered wireless connection associated with a first type of radio access technology (RAT), the first wireless device providing connectivity between the second wireless device and a network; and
receiving, based at least in part on one or more performance parameters associated with the tethered wireless connection, an indication of one or more candidate access points associated with a second type of RAT and within a range of the second wireless device, the one or more candidate access points for a handover of the second wireless device from the first wireless device to maintain the connectivity between the second wireless device and the network.

29. The method of claim 28, wherein receiving the indication of the one or more candidate access points for the handover comprises:
receiving respective wireless characteristics for each of the one or more candidate access points.

30. The method of claim 29, wherein the indication of the one or more candidate access points includes an ordering of the one or more candidate access points in accordance with a handover priority of each candidate access point of the one or more candidate access points, and the handover priority is based at least in part on the respective wireless characteristics for each of the one or more candidate access points.
